(19) United States
(12) Patent Application Publication
(10) Pub. No.: US 2012/0106854 A1
(43) Pub. Date: May 3, 2012

(54) EVENT CLASSIFICATION OF IMAGES FROM FUSION OF CLASSIFIER CLASSIFICATIONS

(76) Inventors: Feng Tang, Mountain View, CA (US); Daniel R. Tretter, San Jose, CA (US); Christopher Willis, Palo Alto, CA (US)

(21) Appl. No.: 12/914,641

(22) Filed: Oct. 28, 2010

(51) Int. Cl. G06K 9/62

(52) U.S. Cl. 382/224

(57) ABSTRACT

A system and a method are disclosed that classify images according to their association with an event. Both metadata and visual content of images in a collection of images can be used for event classification. The confidence scores from the classification using a metadata classifier and from the classification using a visual classifier are combined through a confidence-based fusion to provide the classification for a set of images.

### BACKGROUND

People frequently collect images, including personal photos and family photos, to preserve the memory of events in their lives. These images can be saved on a computer or stored in albums on the web. Typically, a user puts the images into new folders or albums upon completion of the event, such as a after returning from a fun trip for a holiday. Automatic event classification of images would be beneficial for management of an ever-increasing collection of images.

### DESCRIPTION OF DRAWINGS

FIG. 1A is a block diagram of an example of an image classification system for classifying image as to an associated event.

FIG. 1B is a block diagram of an example of a computer system that incorporates an example of the image classification system of FIG. 1A.

FIG. 2 is a block diagram of an illustrative functionality implemented by an illustrative computerized image classification system.

FIG. 3 illustrates a visual analysis performed on images.

FIG. 4 illustrates shows a flow chart of an example process for classifying image as to an associated event.

FIG. 5 illustrates shows a flow chart of another example process for classifying image as to an associated event.

FIG. 6 illustrates an example implementation of an event classification system with images.

FIGS. 7A and 7B show timestamp statistics of images that are related to Christmas event (FIG. 7A) and the 4th of July event (FIG. 7B).

FIGS. 8A and 8B show the relative use of flash versus no flash for capturing images that are related to Christmas event (FIG. 8A) and the 4th of July event (FIG. 8B).

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale.

An “image” broadly refers to any type of visually perceptible content that may be rendered on a physical medium (e.g., a display monitor or a print medium). Images may be complete or partial versions of any type of digital or electronic image, including: an image that was captured by an image sensor (e.g., a video camera, a still image camera, or an optical scanner) or a processed (e.g., filtered, reformatted, enhanced or otherwise modified) version of such an image; a computer-generated bitmap or vector graphic image; a textual image (e.g., a bitmap image containing text); and an iconographic image.

The term “image forming element” refers to an addressable region of an image. In some examples, the image forming elements correspond to pixels, which are the smallest addressable units of an image. Each image forming element has at least one respective “image value” that is represented by one or more bits. For example, an image forming element in the RGB color space includes a respective image value for each of the colors (such as but not limited to red, green, and blue), where each of the image values may be represented by one or more bits.

“Image data” herein includes data representative of image forming elements of the image and image values.

A “computer” is any machine, device, or apparatus that processes data according to computer-readable instructions that are stored on a computer-readable medium either temporarily or permanently. A “software application” (also referred to as software, an application, computer software, a computer application, a program, and a computer program) is a set of machine-readable instructions that a computer can interpret and execute to perform one or more specific tasks. A “data file” is a block of information that durably stores data for use by a software application.

The term “computer-readable medium” refers to any medium capable storing information that is readable by a machine (e.g., a computer system). Storage devices suitable for tangibly embodying these instructions and data include, but are not limited to, all forms of non-volatile computer-readable memory, including, for example, semiconductor memory devices, such as EPROM, EEPROM, and Flash memory devices, magnetic disks such as internal hard disks and removable hard disks, magneto-optical disks, DVD-ROM/RAM, and CD-ROM/RAM.

As used herein, the term “includes” means includes but not limited to, the term “including” means including but not limited to. The term “based on” means based at least in part on.

In the following description, for purposes of explanation, numerous specific details are set forth in order to provide a thorough understanding of the present systems and methods. It will be apparent, however, to one skilled in the art that the present systems and methods may be practiced without these specific details. Reference in the specification to “an embodiment,” “an example” or similar language means that a particular feature, structure, or characteristic described in connection with the embodiment or example is included in at least that one example, but not necessarily in other examples. The various instances of the phrase “in one embodiment” or similar phrases in various places in the specification are not necessarily all referring to the same embodiment.

Creation of multimedia content has become easier, including by professional and amateur photographers, with the advancements in instruments such as digital cameras and video camcorders. As the size of media collections continue to grow, systems and methods for media organization, management and utilization become increasingly important. Images are typically taken to preserve the memory of events. The images can be stored on a computer or in web albums. A user may place multiple images into a computer folder or photo album once an event is over. Different image groups may be present in an image collection related to different events. Automatic event classification of these images would be of value for management of the ever-increasing collection of images.

An event can occur in a certain places during a particular interval of time. From the user's point of view, an event tells a story of an individual's life in a certain period of time. An event can be a social gathering or activity. An event can be related to a public holiday, or a religious holy day. Non-limiting examples of events include Christmas, Chanukkah, New Years, Valentine's Day, Easter, St. Patrick's Day, Memorial, 4th of July, Halloween, Wedding, Christenings, and Funerals. Different events have different characteristics that distinguish them from other events. For example, Christmas can involve a gathering of family and sometimes close friends around a Christmas tree, decorated with ornaments, and dated around December 25. Christmas images can include representative object indications, such as a Christmas tree with ornaments, wrapped presents, and stockings, and figures such as a snowman and Santa Claus. As another example, celebration of Halloween involves dress up in costumes, decorations that depict death and ghouls, and activities dated around October 31.

A system where a user manually labels images as to different events, including when the photos are stored in different folders, requires user interactions. A system that classifies photos only using timestamps, by assuming pictures taken in a certain period of time are associated with a particular event, does not provide any semantic information, including whether the timestamp is correct. A system that organizes photos according to user created folders can yield incorrect classification if a user simply loads photos from the camera to a single folder so that different event photos are mixed together. Consumers may not wish to sort images into folders and manually label them.

The examples that are described herein provide a system and a method for classifying images according to their association with events. The images in a collection may not be randomly captured, that is, they may be related to in some way. A system and a method are provided herein for determining these relationships among the images. In one example, a system and a method are provided for classifying images according to their association with an event. A system and a method also are provided herein for classifying images according to different event categories from a group of images associated with the particular event. A system and a method are provided for using both metadata and visual content of images in a collection of images for classification. The system and method are designed to be scalable, so that new events (including new even categories) can be added without algorithm re-design.

In an example, a system and method described herein can be used to automatically generate printable product recommendations. A system and method can be used to automatically analyze a user's images collection, either on a local computer, or a collection of images uploaded to the web, and can be used to periodically generate printable products, such as photo albums and photobooks including images associated with a particular event. For example, a system and method can be used to automatically generate a Halloween photobook for a user.

In another example, a system and method herein can facilitate a user's navigation and search throughout an entire collection of images. For example, the user can browse all the images according to their event labels. In an example scenario, the user wants to find a particular image, and cannot recall where the image is stored, but does remember that the image was taken during Halloween. That is, classifying the images according to the associated event can help a user narrow their search and find the desired image more quickly.

In yet another example, a system and method described herein can be used to determine social preference. For example, the system and method described herein can be used to determine a user's preferred activity, which can help determine customized services. Many images of soccer event images can indicate that a user is a soccer fan for customized sports-related services.

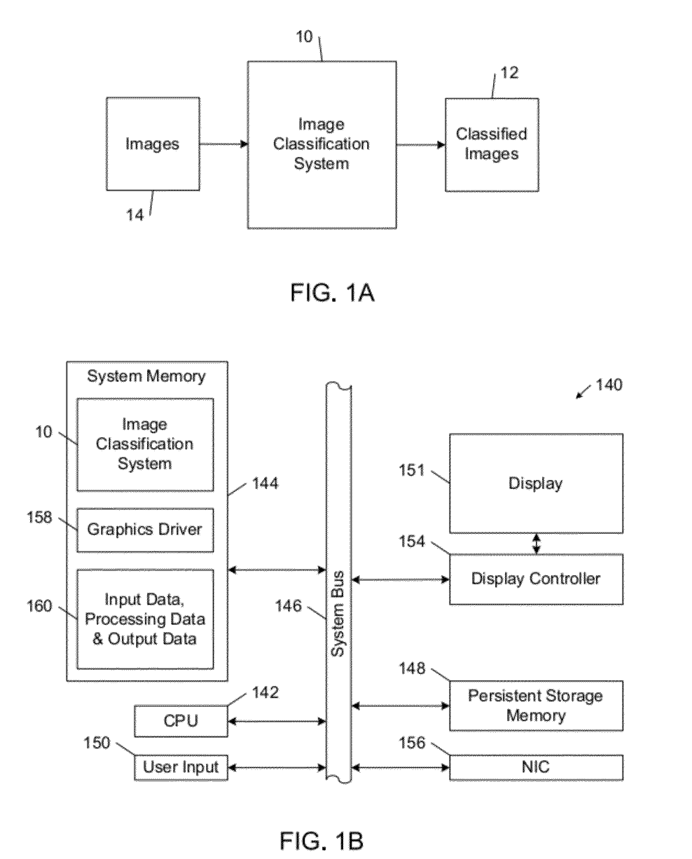

FIG. 1A shows an example of an image classification system 10 that provides classified images 12 from a set of images 14. In particular, the image classification system 10 can be used to classify a set of images 14, using both metadata and visual content of the set of images 14, according to example methods described herein, to provide the classified images 12. The input to the image classification system 10 is a collection of images.

An example source of images 12 in the collection of images is personal photos of a consumer taken of family members and/or friends. An example source of images 12 in the collection of images is images captured by an image sensor of, e.g., entertainment or sports celebrities, or reality television individuals. The images can be taken over a short span of time (minutes), or can have time stamps that extend over several days or weeks. An example of images that span a short space of time is images taken of one or more members of a family near an attraction at an amusement park. In an example use scenario, a system and method disclosed herein is applied to images in a database of images, such as but not limited to images of an area captured from imaging devices (such as but not limited to surveillance devices, or film footage) located at an airport, a stadium, a restaurant, a mall, outside building, etc., as described herein. In another example use scenario, a system and method disclosed herein is applied to images in a database of images, such as but not limited to images captured using imaging devices (such as but not limited to surveillance devices, or film footage) of an area located at an airport, a stadium, a restaurant, a mall, outside an office building or residence, etc. An example implementation of a method disclosed herein is applying image classification system 10 to images captured by an image capture device installed in a monitored location. It will be appreciated that other sources are possible.

Sources of information on the images that are used for event classification include metadata associated with the images and visual features of the images. Visual features of an image can be obtained using the image forming elements of the image. Metadata, often referred to as “data about data,” provides information about the primary content of multimedia data. Metadata includes information that can be used to organize and search through libraries of images and video content. For example, a digital camera can record, in each photo's EXIF header, a set of metadata such as camera model, shot parameter and image properties. A desirable property of metadata is that it can be very easily extracted.

Examples of types of metadata include timestamp, flash or nonflash, exposure time, and focal length. The timestamp may indicate when the image was taken. Use of a flash can indicate a particular event that occurs chiefly at night, such as Halloween. The exposure time can indication whether the picture was taken indoors or outdoors. Metadata may not be reliable by itself to classify an image collection as to an event. For example, the clock of a camera may not have been set properly, in which case all the timestamps may be wrong. The system and methods disclosed herein use both metadata and visual analysis for image classification.

FIG. 1B shows an example of a computer system 140 that can implement any of the examples of the image classification system 10 that are described herein. The computer system 140 includes a processing unit 142 (CPU), a system memory 144, and a system bus 146 that couples processing unit 142 to the various components of the computer system 140. The processing unit 142 typically includes one or more processors, each of which may be in the form of any one of various commercially available processors. The system memory 144 typically includes a read only memory (ROM) that stores a basic input/output system (BIOS) that contains start-up routines for the computer system 140 and a random access memory (RAM). The system bus 146 may be a memory bus, a peripheral bus or a local bus, and may be compatible with any of a variety of bus protocols, including PCI, VESA, Microchannel, ISA, and EISA. The computer system 140 also includes a persistent storage memory 148 (e.g., a hard drive, a floppy drive, a CD ROM drive, magnetic tape drives, flash memory devices, and digital video disks) that is connected to the system bus 146 and contains one or more computer-readable media disks that provide non-volatile or persistent storage for data, data structures and computer-executable instructions.

A user may interact (e.g., enter commands or data) with the computer system 140 using one or more input devices 150 (e.g., a keyboard, a computer mouse, a microphone, joystick, and touch pad). Information may be presented through a user interface that is displayed to a user on the display 151 (implemented by, e.g., a display monitor), which is controlled by a display controller 154 (implemented by, e.g., a video graphics card). The computer system 140 also typically includes peripheral output devices, such as speakers and a printer. One or more remote computers may be connected to the computer system 140 through a network interface card (NIC) 156.

As shown in FIG. 1B, the system memory 144 also stores the image classification system 10, a graphics driver 158, and processing information 160 that includes input data, processing data, and output data. In some examples, the image classification system 10 interfaces with the graphics driver 158 to present a user interface on the display 151 for managing and controlling the operation of the image classification system 10.

In general, the image classification system 10 typically includes one or more discrete data processing components, each of which may be in the form of any one of various commercially available data processing chips. In some implementations, the image classification system 10 is embedded in the hardware of any one of a wide variety of digital and analog computer devices, including desktop, workstation, and server computers. In some examples, the image classification system 10 executes process instructions (e.g., machine-readable code, such as computer software) in the process of implementing the methods that are described herein. These process instructions, as well as the data generated in the course of their execution, are stored in one or more computer-readable media. Storage devices suitable for tangibly embodying these instructions and data include all forms of non-volatile computer-readable memory, including, for example, semiconductor memory devices, such as EPROM, EEPROM, and flash memory devices, magnetic disks such as internal hard disks and removable hard disks, magneto-optical disks, DVD-ROM/RAM, and CD-ROM/RAM.

The principles set forth in the herein extend equally to any alternative configuration in which image classification system 10 has access to a set of images 14. As such, alternative examples within the scope of the principles of the present specification include examples in which the image classification system 10 is implemented by the same computer system, examples in which the functionality of the image classification system 10 is implemented by a multiple interconnected computers (e.g., a server in a data center and a user's client machine), examples in which the image classification system 10 communicates with portions of computer system 140 directly through a bus without intermediary network devices, and examples in which the image classification system 10 has a stored local copies of the set of images 14 that are to be classified.

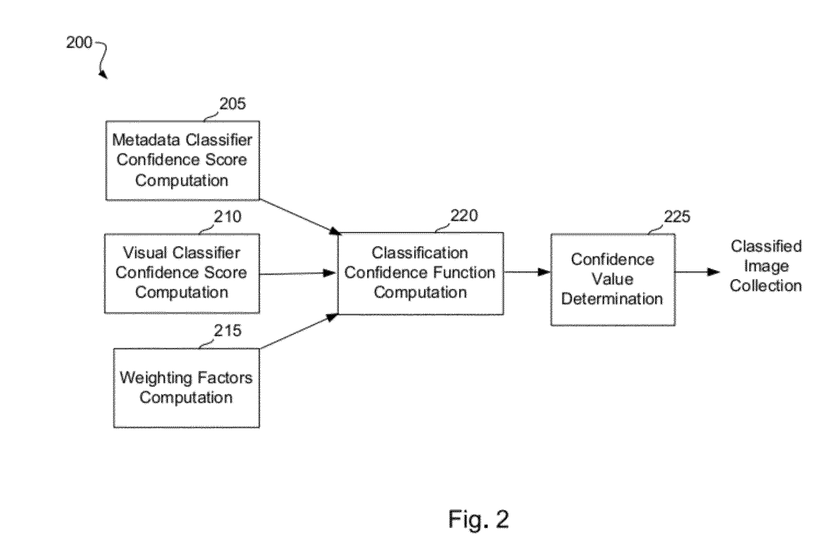

Referring now to FIG. 2, a block diagram is shown of an illustrative functionality 200 implemented by image classification system 10 for classifying images according to their association with an event, consistent with the principles described herein. Each module in the diagram represents an element of functionality performed by the processing unit 142. Arrows between the modules represent the communication and interoperability among the modules.

The operations in block 205 of FIG. 2 are performed on metadata feature data associated with images of the set of images. The operations in block 210 of FIG. 2 are performed on visual feature data representative of images of the set of images. The images can be retrieved from a folder in a local computer or can be obtained over a network, from for example a web album, using a URL received by a receiving module. Such a receiving module may perform the functions of fetching the image from its server. The URL may be specified by a user of the image classification system 10 or, alternatively, be determined automatically. For the purposes of describing FIG. 2, the collection of images can be represented as I={I₁, . . . ,Iᵢ, . . . ,Iₙ} where Iᵢ denotes a single image, where n is the total number of images in the collection, and the different candidate events (Eⱼ) can be denoted as I={E₁, . . . ,Eⱼ, . . . ,Eₖ}, where k is the total number of candidate events. Individual classifiers are built for classifying metadata features (a metadata classifier) and for classifying visual features (visual classifier). The classification results from the classifiers are combined through information fusion to provide a set of classified images. A confidence-based fusion is used to produce the final event classification based on both visual feature data and metadata feature data. The confidence-based fusion takes into account the relative reliability of both the visual feature data and the metadata feature data, as well as the reliability of each feature across different events.

In block 205, a metadata classifier confidence score is computed by a module based on the performance of a metadata classifier in classifying the images as event based on metadata feature data and the output of the metadata classifier. The metadata classifier confidence score computation can be performed by a confidence score computation module. For each image in the set of images, the metadata classifier confidence score computation module is used to determine a metadata classifier confidence score for each event of a number of events. The metadata classifier confidence score is computed based on a metadata classifier confusion matrix, which is constructed from the results of applying the metadata classifier to metadata associated with the images, and the output of the metadata classifier applied to each image. The metadata classifier confusion matrix provides an indication of the performance of the metadata classifier for classifying the image as being associated with a particular event.

Examples of the types of metadata to which the metadata classifier can be applied include timestamp, flash or nonflash, exposure time, and focal length. Metadata other that timestamps can be useful in distinguish different events. The correlations among the metadata can be complex. A metadata classifier is built, using training images with known event association, to classify an image as to its association with an event based on the metadata. The metadata classifier is applied to the metadata feature data for the images to provide a classification output for each event. For example, the metadata classifier may give a high score for the event(s) it determines the image is likely associated with, and a low score for events it determines the image is not likely associated with. The metadata classifier can give the score in the form of a probability. The metadata classifier can be built using any statistical and/or machine learning technique available in the art. The complex interactions among the metadata variables are implicitly captured within the metadata classifier structure.

As a non-limiting example, the metadata classifier can be a random forest classifier. A random forest classifier can be built using metadata information to minimize the classification error. For example, Breiman, 2001, “Random forests,” Machine Learning, 45:5-32 provides a framework for tree ensembles called “random forests.” Each decision tree depends on the values of a random vector sampled independently and with the same distribution for all trees. Thus, a random forest is a classifier that consists of many decision trees and outputs the class that is the mode of the classes output by individual trees. Random forest classifiers can give excellent performance and can work fast. Single tree classifiers, such as but not limited to a Classification And Regression Tree (CART), also can be used.

The output of the metadata classifier can be expressed as a probability of an image being classified as to each event of the number of events. That is, for each image Iᵢ, the metadata classifier can be used to yield a probability vector over the number of events, expressed as pᵢ^{m}=[p_{i,1}^{m}, . . . ,p_{i,j}^{m}, . . . ,p_{i,k}^{m}], where each p_{i,j}^{m} denotes the probability of the metadata classifier classifying the image Iᵢ as being associated with event Eⱼ using metadata features.

A metadata classifier confusion matrix is computed based on the performance of the metadata classifier in classifying training images with known event association. The confusion matrix is comprised of values that quantify the event classification from the metadata classifier versus the actual event class of the image. That is, the confusion matrix shows, for each pair of classes <c₁,c₂>, how many documents from c₁ were incorrectly assigned to c₂. In a non-limiting example, each column of the metadata classifier confusion matrix represents the instances in a predicted class (the classified event using the metadata classifier) and each row represents the instances in an actual class (the actual event associated with the image).

The metadata classifier confidence score for each event is computed based on the metadata classifier confusion matrix of the performance of the metadata classifier. For example, the metadata classifier confidence score can be computed based on the confusion matrix as a mean squared error, classification error, or exponential loss, or similar measure that summarizes the predictive power of the metadata classifier as value. The metadata classifier confidence score for each event can be expressed as a vector of confidence scores. For example, the metadata classifier confidence scores can be expressed in vector form as W^{m}=[w₁^{m}, . . . ,wⱼ^{m}, . . . ,wₖ^{m}], where wⱼ^{m} is the metadata classifier confidence score of the metadata classifier for event Eⱼ.

In block 210, a visual classifier confidence score is computed by a module based on the performance of a visual classifier in classifying the images as event based on visual feature data and the output of a visual classifier applied to each image. The visual classifier confidence score computation can be performed by a confidence score computation module. For each image in the set of images, the visual classifier confidence score computation module is used to determine a visual classifier confidence score for each event of a number of events, and the output of a visual classifier applied to each image. The visual classifier confidence score is computed based on a visual classifier confusion matrix, which is constructed from the results of applying the visual classifier to visual feature data representative of each image. The visual classifier confusion matrix provides an indication of the performance of the visual classifier for classifying the image as being associated with a particular event.

The image forming elements of the images can be used to provide the visual feature data. For example, the image forming elements of the images, such as but not limited to the pixels within each image, can be used to provide the visual feature data. The extracted visual feature data is used for event classification using the visual classifier. For example, visual feature data can be obtained based on advanced invariant local features, such as using a scale-invariant feature transform (SIFT) in computer vision to detect and describe local features in images. See, e.g., D. G. Lowe, 2004, Distinctive Image Features from Scale-Invariant Keypoints, International Journal of Computer Vision 60(2): 91-110. As another example, visual feature data can be obtained using a bag-of-features model in image retrieval. See, e.g., D. Nister et al., 2006, Scalable recognition with a vocabulary tree, IEEE CVPR, pages 2161-2168, and J. Sivic et al., 2003, Video Google: A text retrieval approach to object matching in videos, IEEE ICCV, 2: 1470-1477. Invariant local features can be used to represent images such that they are robust to illumination/viewpoint changes and occlusion.

The bag-of-features model is used to create a unique and compact digital signature or fingerprint for each image. The bag-of-feature model has an offline training process, where invariant local features are extracted from image database and are clustered to form a set of feature primitives which is called a visual vocabulary. For example, dense sample of every 8 pixels can be used. Each feature primitive in this vocabulary is called a visual word and has a visual identification (visual ID). In order to obtain the visual word vocabulary, an efficient feature clustering method can be used. For example, clustering methods like k-means or Expectation Maximization (EM) can be used. As another example, a clustering method that is scalable to a large number of images, such as fast k-means clustering, can be used to cluster a large number of features. In an example fast k-means clustering, each iteration of k-means is accelerated by building a random forest, a variation of kd-tree, on the cluster centers. See, e.g., J. Philbin et al., 2007, Object Retrieval with Large Vocabularies and Fast Spatial Matching, IEEE CVPR pages 1-8. This reduces the complexity from order of n×n [i.e., O(n×n)] to order of n×log(n) [i.e., O(nlogn)], where n is the number of features to be clustered, and accelerates the clustering process. This visual word vocabulary serves as a quantization of the feature descriptor space. For each image of the collection of images in the database, and an image to be recognized, first dense local features are extracted and each feature is assigned a visual ID of the corresponding visual word. Then a visual word frequency vector can be built with each element as the number of features that are closest to that visual word.

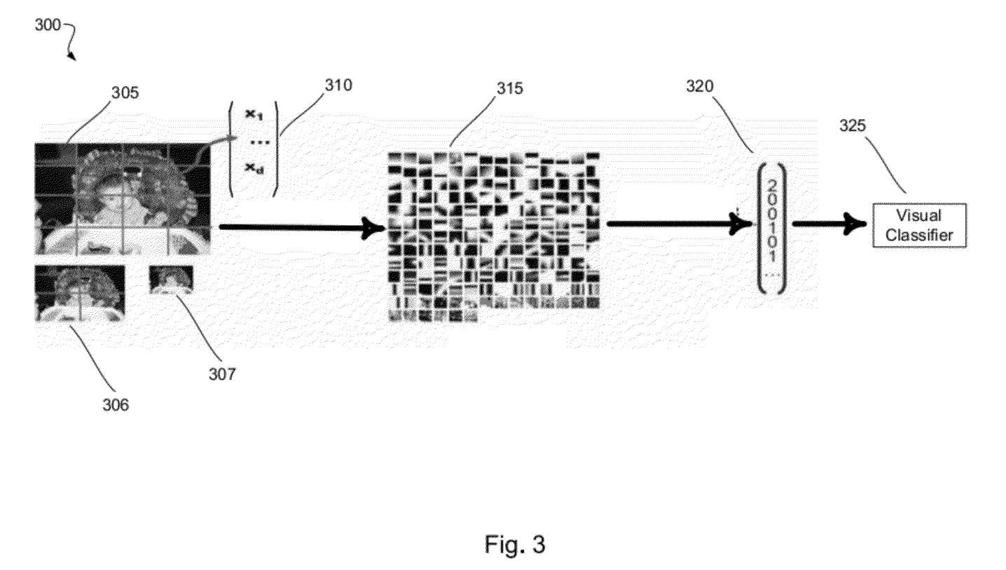

FIG. 3 illustrates a non-limiting example computation of visual feature data that by a module. In order to incorporate spatial information within an image 305, the image 305 is further divided into subregions 310. For each subregion, a visual word frequency vector is computed by comparing the subregion to a codebook of image subregions. The codebook is populated by image subregions of training images having known event association. In the illustrated multiscale computation, a reduced scale version of the image 306 is also further divided into subregions and compared to the codebook to compute a visual word frequency vector for each subregion. Another further reduced scale version of the image 307 is also further divided into subregions and compared to the codebook to compute a visual word frequency vector for each subregion. The visual word frequency vectors for the subregions from the various multiscale computations are concatenated to form a frequency vector representation 320 for the image. The concatenated frequency vector representation is visual feature data for the image. For example, local features can be clustered into 200 clusters and 21 subregions, so the total feature vector for the entire image is a 4200 dimensional histogram that is visual feature data for the image. The operation illustrated in FIG. 3 can be performed on each image in the collection of images, e.g., in the database, to provide a concatenated frequency vector representations (visual feature data) for each image.

A visual classifier is applied to the visual feature data for the images to provide a classification output for each event. For example, the visual classifier may give a high score for the event(s) it determines the image is likely associated with, and a low score for events it determines the image is not likely associated with. The visual classifier can give the score in the form of a probability. A non-limiting example of a visual classifier is a support vector machine (SVM) classifier. For example, the frequency vector representations from the computation of FIG. 3 can be input to a visual classifier 325 to provide a classification of the image as to at least one event. In FIG. 3, the frequency vector representation is based on histograms, and a histogram intersection kernel can be used due to improved performance on histogram-based classifications. The example computation of FIG. 3 is scalable such that new events can be added without new algorithm designs.

The output of the visual classifier can be expressed as a probability of an image being classified as to each event of the number of events. That is, for each image Iᵢ, the visual classifier can be used to yield a probability vector over the number of events, expressed as pᵢ^{v}=[p_{i,1}^{v}, . . . ,p_{i,j}^{v}, . . . ,p_{i,k}^{v}], where each p_{i,j}^{v} denotes the probability of the visual classifier classifying the image Iᵢ as being associated with event Eⱼ using visual feature data.

A visual classifier confusion matrix is computed based on the performance of the visual classifier in classifying training images with known event association. The confusion matrix is comprised of values that quantify the event classification from the visual classifier versus the actual event class of the image. In a non-limiting example, each column of the visual classifier confusion matrix represents the instances in a predicted class (the classified event using the visual classifier) and each row represents the instances in an actual class (the actual event associated with the image).

The visual classifier confidence score for each event is computed based on the visual classifier confusion matrix of the performance of the visual classifier. For example, the visual classifier confidence score can be computed based on the confusion matrix as a mean squared error, classification error, or exponential loss, or similar measure that summarizes the predictive power of the visual classifier as value. The visual classifier confidence score for each event can be expressed as a vector of confidence scores. For example, the visual classifier confidence scores can be expressed in vector form as W^{v}=[w₁^{v}, . . . ,wⱼ^{v}, . . . ,wₖ^{v}], where wⱼ^{v} is the visual classifier confidence score of the visual classifier for event Eⱼ.

In block 215, weighting factors indicative of relative reliability of the visual classifier and of the metadata classifier for classifying images as to events are computed. The weighting factor puts a weight on each of the metadata classifier and the visual classifier, to provide a measure of how reliable each is for classifying an image as to an event. If the weighting factor for classification using the metadata classifier is denoted as α the weighting factor for classification using the visual classifier is denoted as 1−α.

As a non-limiting example, the weighting factors can be computed from the results of applying the metadata classifier and the visual classifier to training images having known event classification. For example, for a number (N) of training images, the metadata classifier can correctly classify N^{m} training images, and the visual can classifier correctly classify N^{v} training images, where N=N^{m}+N^{v}. The weighting factor for classification using the metadata classifier is computed as

$$α = \frac{{N}^{m}}{{N}^{m} + {N}^{v}} .$$

The weighting factor for classification using the visual classifier is denoted as 1−α.

In block 220, a classification confidence function computation is performed. The classification confidence function can be configured as a two-level weighting function that takes into account within feature (visual or metadata) but cross-event category weighting (obtained from block 205 and block 210), and feature level weighting (obtained from block 215).

The within feature (visual or metadata) but cross-event category weighting portion of the classification confidence function computation takes into account a scenario where, for the same feature (whether a visual feature or a metadata feature), the respective classifier, whether the visual classifier or the metadata classifier, respectively, perform differently for different events. For example, for a visual classifier using visual feature data, Christmas can be an easier event to identify than Valentine's Day, since Christmas images can have more consistent visual feature data.

The feature level weighting portion of the classification confidence function computation takes into account a scenario where the performance of the metadata classifier and the visual classifier is different. For example, a metadata classifier can be more reliable to classify an image as to a date-correlated event like Christmas, based on metadata such as date stamp, than a visual classifier can classify based on the visual feature data.

In a non-limiting example, a classification confidence function computation for each image is performed based on a classification confidence function for classifying an image Iᵢ as to event Eⱼ, expressed as [C(i,j)]:

C(i,j)=αwⱼ^{m}p_{i,j}^{m}+(1−α)wⱼ^{v}p_{i,j}^{v},

where i denotes each image of the set of n images (i=1, n), j denotes each event of the number of k events (j=1, . . . , k), wⱼ^{m} is the metadata classifier confidence score for each event, p_{i,j}^{m} is the probability of classifying image i as being associated with event j using metadata associated with image i, wⱼ^{v} is the visual classifier confidence score for each event, and p_{i,j}^{v} is the probability of classifying image i as being associated with event j using visual feature data representative of image i.

The classification confidence function computations for each image Iᵢ can be combined for the collection of images to provide a collection level classification confidence for classifying the collection of images I as being associated with event Eⱼ. In a non-limiting example, the collection level classification confidence can be computed as a summation of the classification confidence function computations for each image Iᵢ of the collection of images I according to the expression [C(i,j)]:

$${C}_{v} ( I , j ) = {\sum }_{i = 1}^{n} α {w}_{j}^{m} {p}_{i , j}^{m} + ( 1 - α ) {w}_{j}^{v} {p}_{i , j}^{v}$$

wherein I is the set of images (i=1, . . . , n) in the collection.

In an example, where the collection of images does not have associated metadata, the computations described in connection with block 205 and 215 are not performed, and the computation of block 210 is performed and the results provided to block 220 for performing the computation of a visual classification confidence function. The visual classification confidence function computation for each image can be performed based on a classification confidence function for classifying an image Iᵢ as to event Eⱼ, expressed as [Cᵥ(i, j)]:

Cᵥ(i,j)=wⱼ^{v}p_{i,j}^{v}

where i denotes each image of the set of n images (i=1, . . . , n), j denotes each event of the number of k events (j=1, . . . , k), wⱼ^{v} is the visual classifier confidence score for each event, and p_{i,j}^{v} is the probability of classifying image i as being associated with event j using visual feature data representative of image i. The visual classification confidence function computations for each image Iᵢ can be combined for the collection of images to provide a collection level visual classification confidence for classifying the collection of images I as being associated with event Eⱼ. The collection level classification confidence can be computed as a summation of the classification confidence function computations for each image Iᵢ of the collection of images I according to the expression [Cᵥ(i,j)]:

$${C}_{v} ( I , j ) = {\sum }_{i = 1}^{n} α {w}_{j}^{m} {p}_{i , j}^{m} + ( 1 - α ) {w}_{j}^{v} {p}_{i , j}^{v}$$

wherein I is the set of images (i=1, . . . , n) in the collection.

In block 225, a confidence value for each event is computed from the combination of the classification confidence functions (the collection level classification confidence) for the set of images in the collection derived in block 220. In the example where the collection of images does not have associated metadata, a confidence value for each event is computed from the combination of the visual classification confidence functions (the collection level visual classification confidence) for the set of images in the collection derived in block 220. The event having the highest confidence value is determined as the event with which the collection of images is associated

In an example, the event j having the highest confidence value is determined using the following expression:

$${argmax}_{j} C ( I , j ) .$$

In an example, at least one event of the number of events can be classified in multiple different event subcategories. For example, each event subcategory can be different stages of a holiday celebration, or different days of a preparation for an event. The operations of blocks 210 through 225 are scalable, such that the visual classifier and the metadata classifier can be trained to classify according to the different event subcategories, and used as described in blocks 210 through 225 to classify images of the collection of images as being associated with at least one of the event subcategories.

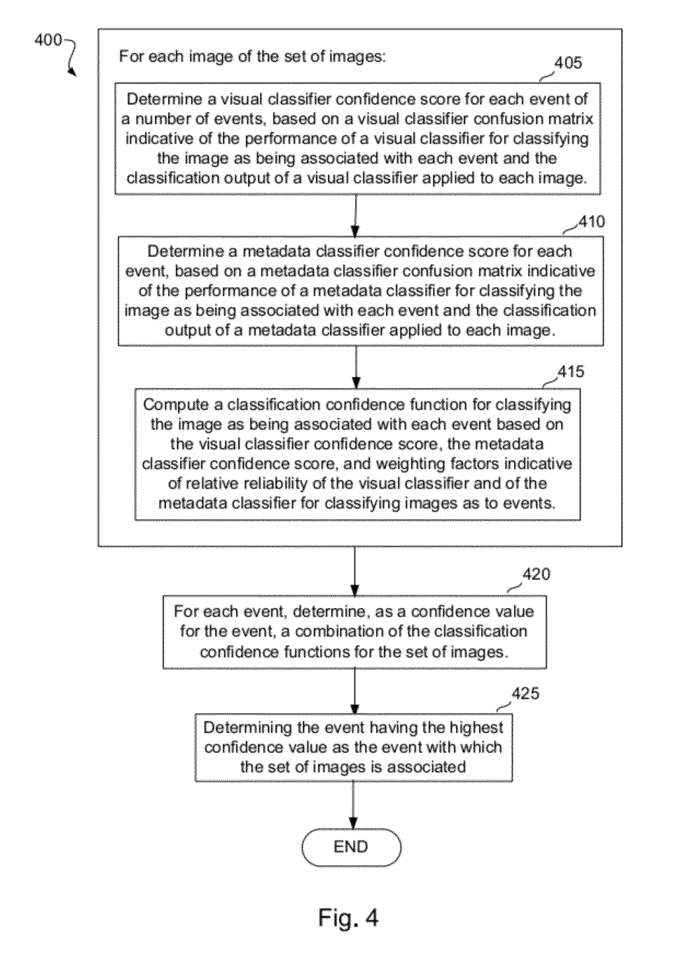

FIG. 4 shows a flow chart of an example process for event classification of images from a collection. The processes of FIG. 4 can be performed by modules as described in connection with FIG. 3. In block 405, for each image of a set of images, a visual classifier confidence score is determined for each event of a number of events, based on a visual classifier confusion matrix that indicate the performance of a visual classifier for classifying the image as being associated with each event and the output of the visual classifier for the image. In block 410, for each image of a set of images, a metadata classifier confidence score is determined for each event, based on a metadata classifier confusion matrix indicative of the performance of a metadata classifier for classifying the image as being associated with each event and the output of the metadata classifier for the image. In block 415, a classification confidence function is computed for classifying the image as being associated with each event based on the visual classifier confidence score of block 405, the metadata classifier confidence score of block 410, and weighting factors that of relative reliability of the visual classifier and of the metadata classifier for classifying images as to the events. In block 420, for each event, a combination of the classification confidence functions for the set of images is determined as a confidence value for the event. In block 425, the event having the highest confidence value is determined as the event with which the set of images is associated.

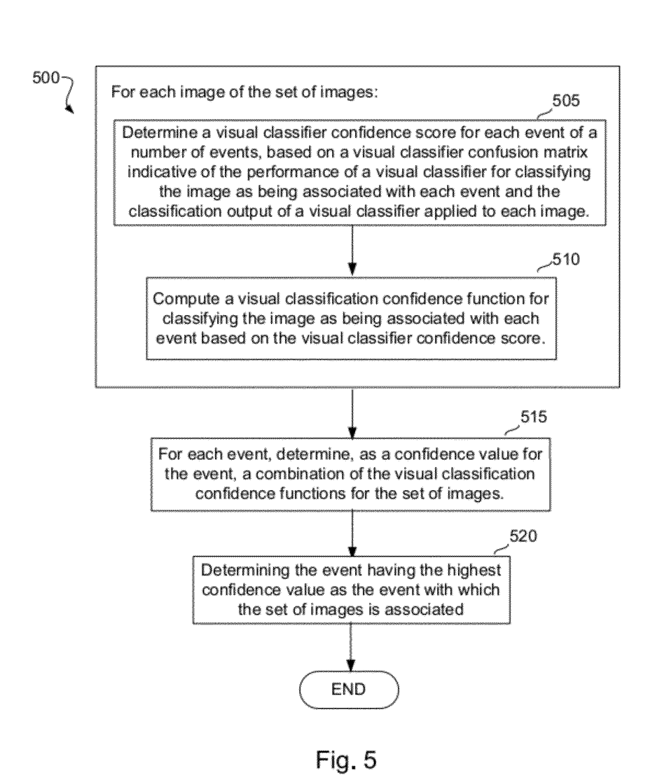

FIG. 5 shows a flow chart of an example process for event classification of images from a collection. The processes of FIG. 5 can be performed by modules as described in connection with FIG. 3. In block 505, for each image of a set of images, a visual classifier confidence score is determined for each event of a number of events, based on a visual classifier confusion matrix that indicate the performance of a visual classifier for classifying the image as being associated with each event. In block 510, a visual classification confidence function is computed for classifying the image as being associated with each event based on the visual classifier confidence score of block 505. In block 515, for each event, a combination of the visual classification confidence functions for the set of images is determined as a confidence value for the event. In block 520, the event having the highest confidence value is determined as the event with which the set of images is associated.

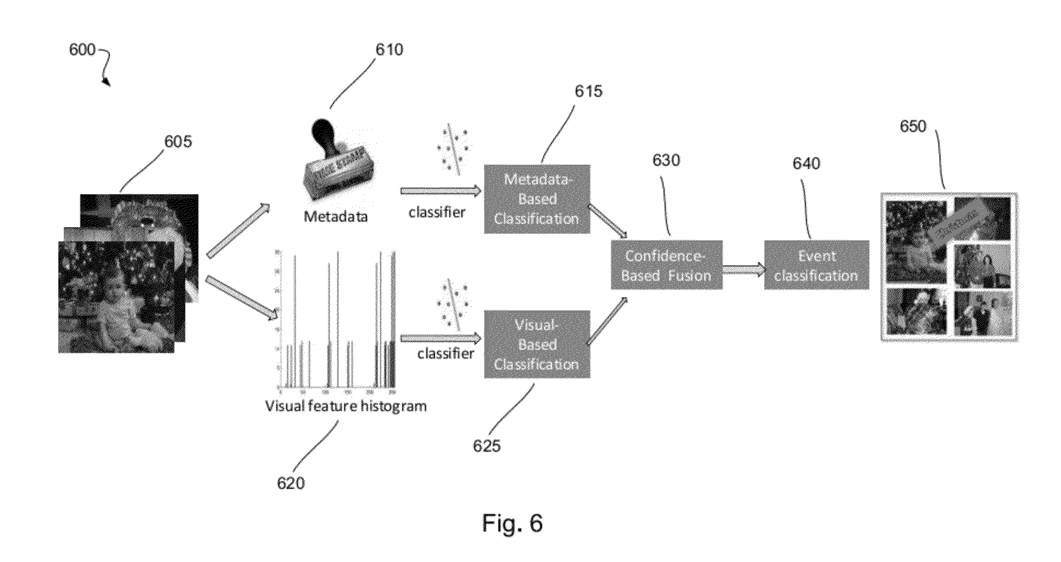

FIGS. 6-8 illustrate an example application of a system and method described herein for event classification of images from a collection. FIG. 6 shows an example collection of photographs to be classified as to association with an event. Analysis was performed based on metadata feature data 610 and visual feature data 620 from the photo collection. The classification performance is evaluated using confusion matrices. Each column of the confusion matrices represents the instances in a predicted class, while each row represents the instances in an actual class. A method disclosed herein was applied to a dataset to classify relative to four (4) events: Christmas, Halloween, Valentine's Day and 4th of July.

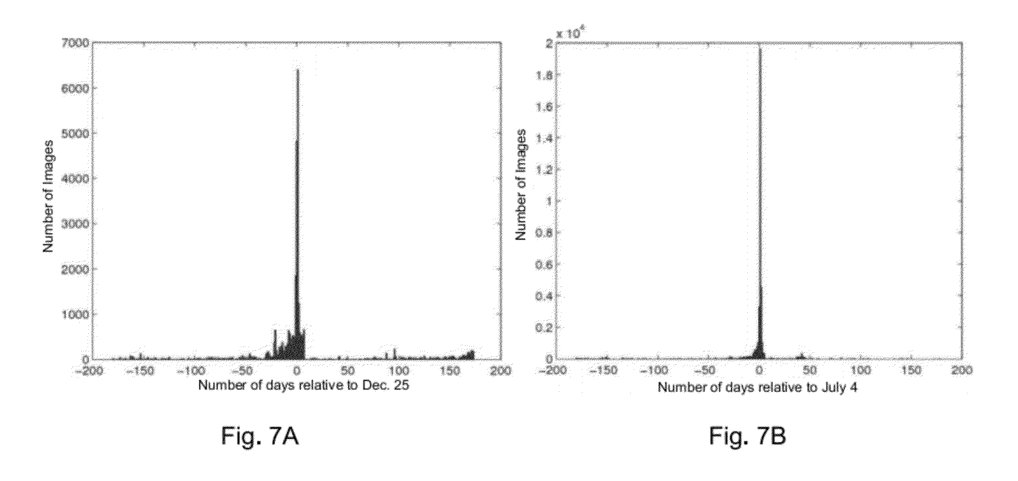

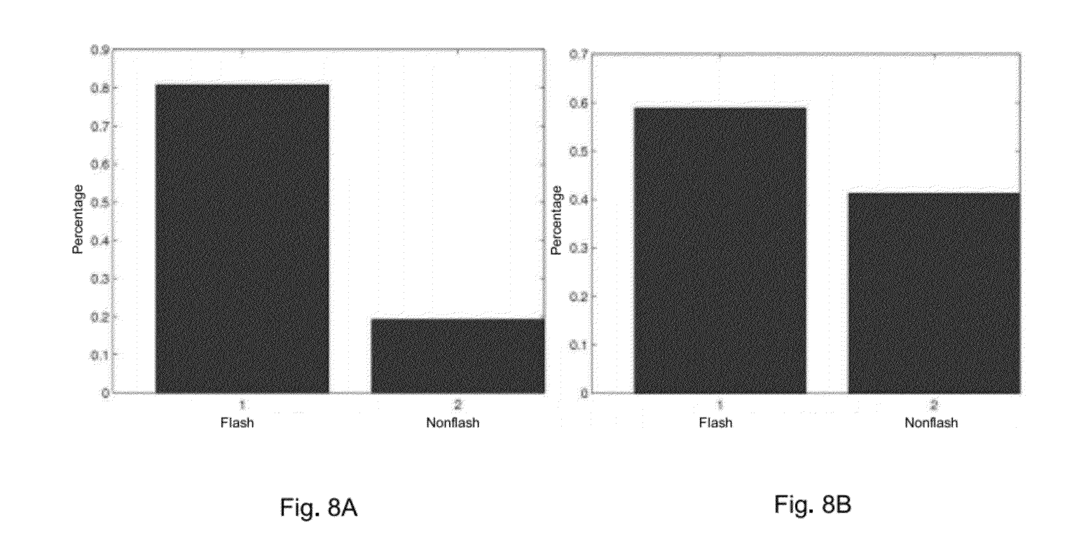

FIGS. 7A, 7B, 8A, and 8B show metadata statistics (timestamp and flash/nonflash) that can be used to classify images. FIGS. 7A and 7B show timestamp statistics of Christmas photos (FIG. 7A) and 4th of July photos (FIG. 7B). As is shown, Christmas photos are taken over a broader timestamp span than 4^{th} of July. Since Christmas can be a major event, preparations may begin from over a month prior to December 25. The timestamps for the 4^{th} of July can be relatively short. FIGS. 8A and 8B show the relative use of flash versus no flash for Christmas (FIG. 8A) as compared to the 4^{th} of July (FIG. 8B). Christmas collections are mostly captured with flash (FIG. 8A), since Christmas activities are mainly conducted indoors in dimmer lighting, such as a family gathering for dinner. By comparison, nonflash photos are taken as a greater percentage of the 4^{th} of July images (see FIG. 8B).

Table 1 shows the confusion matrix for the classification of a dataset of 5000 images, using a metadata classifier, as to association with the indicated events. All available metadata associated with the images are used for the classification, including time, exposure time, flash on, focal length. The dataset was split in half using the image name to remove any bias introduced by random sampling to the dataset due to duplicate images. A half of the images were used for training classifiers and the other half of the images was used for actual classification. There was no overlap between images used for training and images used for actual classification. A null class called “None of the above” (NOA) was designated for images that did not belong to any of the indicated events.

TABLE 1
Confusion matrix for metadata classification performance

| | | | | | Outdoor | | | |
|---|---|---|---|---|---|---|---|---|
| | Christmas | Halloween | Valentines | July 4 | sports | Birthday | Beach | NOA |
| Christmas | 0.9060 | 0.0100 | 0 | 0 | 0 | 0.0580 | 0 | 0.0260 |
| Halloween | 0.0280 | 0.8500 | 0.0080 | 0 | 0.0600 | 0.0020 | 0.0600 | 0.0460 |
| Valentines | 0.0040 | 0.0440 | 0.7820 | 0 | 0.0120 | 0.0460 | 0 | 0.1120 |
| 4July | 0.0320 | 0.0400 | 0 | 0.8280 | 0 | 0.0800 | 0 | 0.0200 |
| Outdoor | 0 | 0.0300 | 0.0320 | 0 | 0.1900 | 0.2640 | 0.0060 | 0.4780 |
| sports | | | | | | | | |
| Birthday | 0.1600 | 0.0860 | 0.0640 | 0.0580 | 0.2260 | 0.1660 | 0 | 0.2400 |
| Beach | 0 | 0.0300 | 0.0320 | 0 | 0.1900 | 0.1640 | 0.1060 | 0.4780 |
| NOA | 0.0120 | 0.0200 | 0.0420 | 0.0060 | 0.0880 | 0.1360 | 0.0060 | 0.6900 |

Visual analysis also was performed on the dataset of 5000 images using a method described herein. Table 2 shows the confusion matrix for the results of visual classification using a visual classifier.

TABLE 2
Confusion matrix for visual classification performance

| | | | | | Outdoor | | | |
|---|---|---|---|---|---|---|---|---|
| | Christmas | Halloween | Valentines | July 4 | sports | Birthday | Beach | NOA |
| Christmas | 0.7967 | 0.0500 | 0.0267 | 0.0333 | 0 | 0.0333 | 0 | 0.0600 |
| Halloween | 0.0400 | 0.7100 | 0.0500 | 0.0267 | 0 | 0.0533 | 0.0067 | 0.1133 |
| Valentines | 0.0633 | 0.0633 | 0.6333 | 0.0267 | 0.0033 | 0.1133 | 0.0100 | 0.0867 |
| 4July | 0.0300 | 0.0633 | 0.0467 | 0.6700 | 0.0333 | 0.0700 | 0.0133 | 0.0733 |
| Outdoor | 0 | 0 | 0.0067 | 0.0233 | 0.9467 | 0.0033 | 0.0100 | 0.0100 |
| sports | | | | | | | | |
| Birthday | 0.0233 | 0.0600 | 0.0633 | 0.0467 | 0 | 0.7700 | 0.0067 | 0.0300 |
| Beach | 0.0067 | 0 | 0.0233 | 0.0367 | 0.0133 | 0.0333 | 0.8567 | 0.0300 |
| NOA | 0.1067 | 0.1167 | 0.1467 | 0.1000 | 0.0133 | 0.0600 | 0.0500 | 0.4067 |

The collection level classification results are shown in Table 3.

TABLE 3
Collection Level Classification

| | | | | | Outdoor | | | |
|---|---|---|---|---|---|---|---|---|
| | Christmas | Halloween | Valentines | July 4 | sports | Birthday | Beach | NOA |
| Christmas | 0.7895 | 0 | 0 | 0 | 0 | 0.1053 | 0 | 0.1053 |
| Halloween | 0 | 0.7368 | 0 | 0 | 0.0526 | 0.0526 | 0 | 0.1579 |
| Valentines | 0 | 0 | 0.8421 | 0 | 0 | 0.1053 | 0 | 0.0526 |
| 4July | 0 | 0 | 0 | 0.8947 | 0 | 0 | 0 | 0.1053 |
| Outdoor | 0 | 0 | 0 | 0 | 0.8947 | 0 | 0 | 0.1053 |
| sports | | | | | | | | |
| Birthday | 0.0526 | 0.0526 | 0 | 0 | 0 | 0.7368 | 0.1053 | 0.0526 |
| Beach | 0 | 0 | 0.0233 | 0.0367 | 0.0133 | 0.0333 | 0.8567 | 0.1111 |
| NOA | 0.0526 | 0.1053 | 0.0526 | 0 | 0.0526 | 0.0526 | 0.0526 | 0.6316 |

As depicted in FIG. 6, metadata classification 615 is performed on the metadata 610, and visual classification 625 is performed visual feature data (histogram) 620, as described herein. Confidence-based fusion 630 of the metadata classification 615 and the visual classification 625 is performed, as described in connection with any of FIG. 2, 3, 4, or 5, to provide the event classification 640 of the images. In the illustration of FIG. 6, the images are classified as being associated with Christmas.

Many modifications and variations of this invention can be made without departing from its spirit and scope, as will be apparent to those skilled in the art. The specific examples described herein are offered by way of example only, and the invention is to be limited only by the terms of the appended claims, along with the full scope of equivalents to which such claims are entitled.

As an illustration of the wide scope of the systems and methods described herein, the systems and methods described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situation where only the disjunctive meaning may apply.

All references cited herein are incorporated herein by reference in their entirety and for all purposes to the same extent as if each individual publication or patent or patent application was specifically and individually indicated to be incorporated by reference in its entirety herein for all purposes. Discussion or citation of a reference herein will not be construed as an admission that such reference is prior art to the present invention.

What is claimed is:

1. A method for classifying a set of images, said method comprising:
for each image of the set of images:
determining, using a processor, a visual classifier confidence score for each event of a number of events, based on a visual classifier confusion matrix indicative of the performance of a visual classifier for classifying the image as being associated with each event and the classification output of a visual classifier applied to each image;
determining, using a processor, a metadata classifier confidence score for each event, based on a metadata classifier confusion matrix indicative of the performance of a metadata classifier for classifying the image as being associated with each event and the classification output of a metadata classifier applied to each image; and
computing, using a processor, a classification confidence function for classifying the image as being associated with each event based on the visual classifier confidence score, the metadata classifier confidence score, and weighting factors indicative of relative reliability of the visual classifier and of the metadata classifier for classifying images as to events;
for each event, determining, as a confidence value for the event, a combination of the classification confidence functions for the set of images; and
determining the event having the highest confidence value as the event with which the set of images is associated.

2. The method of claim 1, wherein the visual classifier is applied to visual feature data representative of each image, for classifying that image as being associated with an event.

3. The method of claim 1, wherein the visual classifier is a support vector machine.

4. The method of claim 1, wherein the metadata classifier is applied to metadata feature data associated with each image, for classifying that image as being associated with an event.

5. The method of claim 1, wherein the metadata classifier is a random forest classifier.

6. The method of claim 1, further comprising:
generating the weighting function by applying the visual classifier and the metadata classifier to a number (N) of training images;
determining the weighting factor of the relative reliability of classifying using the metadata classifier as a value α, wherein
$$α = \frac{{N}^{m}}{{N}^{m} + {N}^{v}} ,$$
wherein N^{m} is the number of the training images reliably classified using the metadata classifier, wherein N^{v} is the number of the training images reliably classified using the metadata classifier, and wherein N=N^{m}+N^{v}; and
determining the weighting factor of the relative reliability of classifying using the visual classifier as a value (1−α).

7. The method of claim 6, wherein the classification confidence function [C(i, j)] for each image is computed using the expression:
C(i,j)=αwⱼ^{m}p_{i,j}^{m}+(1−α)wⱼ^{v}p_{i,j}^{v}
wherein i is each image of the set of n images (i=1, n), wherein j is each event of the number of k events (j=1, . . . , k), wherein wⱼ^{m} is the metadata classifier confidence score for each event, wherein p_{i,j}^{m} is the probability of classifying image i as being associated with event j using metadata associated with image i, wherein wⱼ^{v} is the visual classifier confidence score for each event, and wherein p_{i,j}^{v} is the probability of classifying image i as being associated with event j using visual feature data representative of image i.

8. The method of claim 7, wherein the combination of the classification confidence functions for the images of the set of images is a summation of the classification confidence functions [C(i, j)] over the set of images computed using the expression:
$$C ( I , j ) = {\sum }_{i = 1}^{n} α {w}_{j}^{m} {p}_{i , j}^{m} + ( 1 - α ) {w}_{j}^{v} {p}_{i , j}^{j}$$
wherein I is the set of images (i=1, . . . , n).

9. The method of claim 8, wherein the event j having the highest confidence value is determined from the expression:
$${argmax}_{j} C ( I , j ) .$$

10. The method of claim 1, wherein at least one event of the plurality of events comprises multiple event subcategories, wherein the visual classifier and the metadata classifier are trained to classify images according to the different event subcategories, and wherein the method further comprises classifying images of the set of images as being associated with at least one of the event subcategories.

11. A method for classifying a set of images, said method comprising:
for each image of the set of images:
determining, using a processor, a visual classifier confidence score for each event of a number of events, based on a visual classifier confusion matrix indicative of the performance of a visual classifier for classifying the image as being associated with each event and the classification output of a visual classifier applied to each image; and
computing, using a processor, a visual classification confidence function for classifying the image as being associated with each event based on the visual classifier confidence score;
for each event, determining, as a confidence value for the event, a combination of the visual classification confidence functions for the set of images; and
determining the event having the highest confidence value as the event with which the set of images is associated.

12. The method of claim 11, wherein the visual classifier is applied to visual feature data representative of each image, for classifying that image as being associated with an event.

13. The method of claim 11, wherein the visual classifier is a support vector machine.

14. The method of claim 11, wherein the classification confidence function [Cᵥ(i,j)] for each image is computed according to the expression:
Cᵥ(i,j)=wⱼ^{v}p_{i,j}^{v}
wherein i is each image of the set of n images (i=1, . . . , n), wherein j is each event of the number of k events (j=1, . . . , k), wherein wⱼ^{v} is the visual classifier confidence score for each event, and wherein p_{i,j}^{v} is the probability of classifying image i as being associated with event j using visual feature data representative of image i.

15. The method of claim 7, wherein the combination of the classification confidence functions for the images of the set of images is a summation of the classification confidence functions [Cᵥ(i, j)] over the set of images computed according to the expression:
$${C}_{v} ( I , j ) = {\sum }_{i = 1}^{n} α {w}_{j}^{m} {p}_{i , j}^{m} + ( 1 - α ) {w}_{j}^{v} {p}_{i , j}^{v}$$
wherein I is the set of images (i=1, . . . , n).

16. A computerized apparatus, comprising:
a memory storing computer-readable instructions; and
a processor coupled to the memory, to execute the instructions, and based at least in part on the execution of the instructions, to perform operations comprising:
for each image of the set of images:
determining, using a processor, a visual classifier confidence score for each event of a number of events, based on a visual classifier confusion matrix indicative of the performance of a visual classifier for classifying the image as being associated with each event and the classification output of a visual classifier applied to each image;
determining, using a processor, a metadata classifier confidence score for each event, based on a metadata classifier confusion matrix indicative of the performance of a metadata classifier for classifying the image as being associated with each event and the classification output of a metadata classifier applied to each image; and
computing, using a processor, a classification confidence function for classifying the image as being associated with each event based on the visual classifier confidence score, the metadata classifier confidence score, and weighting factors indicative of relative reliability of the visual classifier and of the metadata classifier for classifying images as to events;
for each event, determining, as a confidence value for the event, a combination of the classification confidence functions for the set of images; and
determining the event having the highest confidence value as the event with which the set of images is associated.

17. A computerized apparatus, comprising:
a memory storing computer-readable instructions; and
a processor coupled to the memory, to execute the instructions, and based at least in part on the execution of the instructions, to perform operations comprising:
for each image of the set of images:
determining, using a processor, a visual classifier confidence score for each event of a number of events, based on a visual classifier confusion matrix indicative of the performance of a visual classifier for classifying the image as being associated with each event and the classification output of a visual classifier applied to each image; and
computing, using a processor, a visual classification confidence function for classifying the image as being associated with each event based on the visual classifier confidence score;
for each event, determining, as a confidence value for the event, a combination of the visual classification confidence functions for the set of images; and
determining the event having the highest confidence value as the event with which the set of images is associated.

18. At least one computer-readable medium storing computer-readable program code adapted to be executed by a computer to implement a method comprising:
for each image of the set of images:
determining, using a processor, a visual classifier confidence score for each event of a number of events, based on a visual classifier confusion matrix indicative of the performance of a visual classifier for classifying the image as being associated with each event and the classification output of a visual classifier applied to each image;
determining, using a processor, a metadata classifier confidence score for each event, based on a metadata classifier confusion matrix indicative of the performance of a metadata classifier for classifying the image as being associated with each event and the classification output of a metadata classifier applied to each image; and
computing, using a processor, a classification confidence function for classifying the image as being associated with each event based on the visual classifier confidence score, the metadata classifier confidence score, and weighting factors indicative of relative reliability of the visual classifier and of the metadata classifier for classifying images as to events;
for each event, determining, as a confidence value for the event, a combination of the classification confidence functions for the set of images; and
determining the event having the highest confidence value as the event with which the set of images is associated.

19. At least one computer-readable medium storing computer-readable program code adapted to be executed by a computer to implement a method comprising:
for each image of the set of images:
determining, using a processor, a visual classifier confidence score for each event of a number of events, based on a visual classifier confusion matrix indicative of the performance of a visual classifier for classifying the image as being associated with each event and the classification output of a visual classifier applied to each image; and
computing, using a processor, a visual classification confidence function for classifying the image as being associated with each event based on the visual classifier confidence score;
for each event, determining, as a confidence value for the event, a combination of the visual classification confidence functions for the set of images; and
determining the event having the highest confidence value as the event with which the set of images is associated.
